(19) United States
(12) Patent Application Publication
(10) Pub. No.: US 2006/0102550 A1
(43) Pub. Date: May 18, 2006

(54) Liquid supply and filter assembly

(76) Inventors: Stephen C. P. Joseph, Woodbury, MN (US); Gregory C. Buboltz, Wahpeton, ND (US)

Correspondence Address: 3M INNOVATIVE PROPERTIES COMPANY, PO BOX 33427, ST. PAUL, MN, 55133-3427, US

(21) Appl. No.: 10/992,503

(22) Filed: Nov. 18, 2004

(51) Int. Cl. B01D 35/02

(52) U.S. Cl. 210/464; 210/474; 210/475

(57) ABSTRACT

A liquid supply and filter assembly is disclosed. The liquid supply and filter assembly may be used in combination with a spray device or gun to apply liquid to a substrate.

### FIELD OF THE INVENTION

The present invention relates to liquid supply and filter components and assemblies. The liquid supply and filter components and assemblies are particularly suitable for use in gravity-fed liquid (e.g., paint) spraying devices or spray guns.

### BACKGROUND OF THE INVENTION

Various liquid supply assemblies have been described for use with gravity fed liquid (e.g., paint) spraying devices or spray guns, including those described in International Publication Number WO 98/32539 published on Jul. 30, 1998, U.S. Pat. No. 6,536,687, U.S. Pat. No. 6,588,681, the content of all of which is incorporated herein by reference. The supply assemblies include a number of components such as a mixing cup, a collapsible liner, a lid, an adapter for attaching a portion of the lid to a component of a spraying device, and a filter element.

While the prior art discloses various filter assemblies for use in liquid supply containers, many of the filter assemblies are expensive and/or difficult to remove for applications involving, for example, very viscous liquids or liquids which do not require filtration.

Therefore, there remains a need in the art for liquid supply and filter assemblies for spraying devices that provide desired filtering capabilities, as well as user flexibility regarding the need for a filter during a given application.

### SUMMARY OF THE INVENTION

The present invention is directed to liquid supply and filter assemblies for spraying devices and specific components thereof. The liquid supply and filter assemblies comprise a lid component having a removable filter mesh component attached to an inner surface of the lid. The lid/filter mesh component may be incorporated into known liquid supply assemblies for spraying devices such as those disclosed in International Publication Number WO 98/32539, U.S. Pat. No. 6,536,687, and U.S. Pat. No. 6,588,681.

The liquid supply and filter assemblies of the present invention provide flexibility to a user with regard to the use of a filter element. If the user needs the filter mesh component for a given application, the user uses the lid/filter mesh component as is. If the user does not need the filter mesh component for a particular application, the user may easily remove the filter mesh component by simply pulling a tab extending from the filter mesh component to disengage the filter mesh component from the lid.

Accordingly, the present invention is directed to liquid supply and filter assemblies. In one exemplary embodiment, the liquid supply and filter assembly comprises (a) a lid component comprising a first end suitable for connecting to a reservoir capable of containing one or more liquids; a second end opposite the first end; an inner surface and an outer surface both of which extend from the first end to the second end; and an opening extending through a portion of the lid component from the first end to the second end; and (b) a first removably attached filter component attached to the inner surface of the lid component, wherein the first removably attached filter component comprises a first filter mesh, and a first filter tab extending from the first filter mesh. The exemplary liquid supply and filter assembly may further comprise at least one more removable filter component attached to the inner surface of the lid component.

In a further exemplary embodiment, the present invention is directed to a liquid supply and filter assembly comprising (a) a lid/filter mesh component comprising (i) a lid component comprising a first end suitable for connecting to a reservoir capable of containing one or more liquids; a second end opposite the first end; an inner surface and an outer surface both of which extend from the first end to the second end; and an opening extending through a portion of the lid component from the first end to the second end; and (ii) a first removably attached filter component attached to the inner surface of the lid component, wherein the first removably attached filter component comprises a first filter mesh, and a first filter tab extending from the first filter mesh; (b) a container having (i) at least one container side wall, (ii) a container bottom end, (iii) a container top end having a container opening therein, and (iv) a first set of threads extending along the at least one container side wall; (c) an optional liner, wherein the liner has (i) at least one liner side wall, (ii) a liner bottom end, (iii) a liner top end having a liner opening therein, and (iv) a liner rim extending along and protruding from the liner top end, wherein the liner is capable of containing one or more liquids; and (d) an optional collar, wherein the collar has (i) a top end having a collar opening therein, (ii) a bottom end, (iii) at least one collar side wall extending between the top end and the bottom end, (iv) a collar rim extending along the top end and protruding into the collar opening, and (v) a second set of threads extending along the at least one collar side wall, wherein the second set of threads is capable of engaging with the first set of threads on the container; wherein the lid component, the container, the optional liner and the optional collar are capable of being configured and combined with one another to form a leak proof liquid supply and filter assembly. The leak proof liquid supply and filter assembly is capable of being connecting to a gravity fed liquid spraying device.

The present invention is further directed to specific components that may be used in a liquid supply and filter assembly. In one exemplary embodiment, the present invention is directed to a lid/filter mesh component suitable for use in a liquid supply assembly, wherein the lid/filter mesh component comprises (a) a lid component comprising a first end suitable for connecting to a reservoir capable of containing one or more liquids; a second end opposite the first end; an inner surface and an outer surface both of which extend from the first end to the second end; and an opening extending through a portion of the lid component from the first end to the second end; and (b) a first removably attached filter component attached to the inner surface of the lid component, wherein the first removably attached filter component comprises a first filter mesh, and a first filter tab extending from the first filter mesh. In one desired embodiment, the second end of the lid component has a second end cross-sectional area that is smaller than a first end cross-sectional area.

The present invention is also directed to method of making and using liquid supply and filter assemblies suitable for use on a gravity fed liquid spraying device. In one exemplary embodiment, the method of making a liquid supply and filter assembly comprises the steps of (a) providing a lid component comprising a first end suitable for connecting to a reservoir capable of containing one or more liquids; a second end opposite the first end; an inner surface and an outer surface both of which extend from the first end to the second end; and an opening extending through a portion of the lid component from the first end to the second end; and (b) attaching at least one removable filter component to the inner surface of the lid component, wherein the at least one removable filter component comprises a filter mesh and a filter tab extending from the filter mesh. In one desired embodiment, the at least one removable filter component is attached to the lid component by an ultrasonic welding process.

The present invention is even further directed to spraying devices comprising any of the disclosed liquid supply and filter assemblies or the disclosed specific components that may be used in a liquid supply and filter assembly.

These and other features and advantages of the present invention will become apparent after a review of the following detailed description of the disclosed embodiments and the appended claims.

### BRIEF DESCRIPTION OF THE DRAWINGS

The present invention may be more completely understood in consideration of the following detailed description of various embodiments of the invention in connection with the accompanying drawings, wherein like reference numerals refer to like parts in the several views, and wherein:

FIG. 1 is an exploded perspective view of an exemplary liquid supply and filter assembly according to the present invention;

FIG. 2 is a bottom view of the exemplary lid/filter mesh component in the exemplary liquid supply and filter assembly shown in FIG. 1;

FIG. 3 is an enlarged cross-sectional view of the exemplary lid/filter mesh component of FIG. 2 as viewed along section line 3-3 shown in FIG. 2;

FIG. 4 is an exploded perspective view of another exemplary liquid supply and filter assembly according to the present invention;

FIG. 5 is an enlarged cross-sectional view of the exemplary lid/filter mesh component of FIG. 2 as viewed along section line 3-3 after the filter mesh has been removed; and

FIG. 6 is an enlarged cross-sectional view of the exemplary lid/filter mesh component of FIG. 5 with a secondary filter element attached thereto;

FIG. 7 is a perspective view of an exemplary liquid supply and filter assembly of the present invention attached to a spraying device or spray gun; and

FIG. 8 is a perspective view of an exemplary adapter system for attaching an exemplary liquid supply and filter assembly of the present invention to a spraying device.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the present invention is intended by the use of specific language. Alterations, further modifications, and such further applications of the principles of the present invention discussed are contemplated as would normally occur to one ordinarily skilled in the art to which the invention pertains.

The present invention is directed to liquid supply and filter assemblies for spraying devices, as well as individual components within the liquid supply and filter assemblies. The present invention is particularly directed to a lid component for use in a liquid supply and filter assembly, wherein the lid component comprises a filter mesh component removably attached to an interior surface of the lid component. The lid/filter mesh component of the present invention may be used in a variety of liquid supply and filter assemblies, including, but not limited to, those disclosed in International Publication Number WO 98/32539, U.S. Pat. No. 6,536,687, and U.S. Pat. No. 6,588,681.

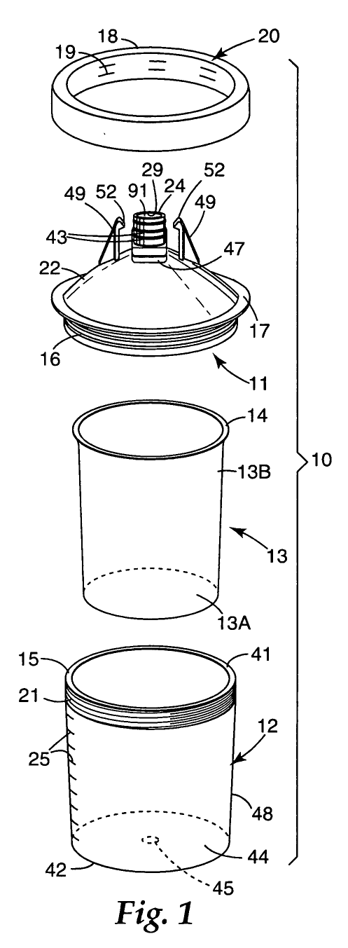

An exemplary liquid supply and filter assembly of the present invention is provided in FIG. 1. As shown in FIG. 1, exemplary liquid supply and filter assembly 10 comprises lid/filter mesh component 11, container 12, liner 13, and collar 20. In this embodiment, liner 13 fits inside container 12 such that liner rim 14 of liner 13 rests on upper container surface 15 of container 12. Lower portion 16 of lid/filter mesh component 11 extends snugly into liner 13 until a lower surface of lid rim 17 comes into contacts with liner rim 14. Collar 20 is used to secure lid/filter mesh component 11 in place by engaging collar threads 19 positioned on an inner surface of collar 20 with container threads 21 positioned on an outer surface of container 12 below upper container surface 15. When screwed tightly, an upper rim 18 of collar 20 is in contact with an upper surface of lid rim 17.

As shown in FIG. 1, exemplary liquid supply and filter assembly 10 of the present invention may comprise a number of components. A description of individual components and methods of using individual components alone or in combination is provided below.

I. Liquid Supply and Filter Assembly Components

The liquid supply and filter assemblies of the present invention may comprise one of more of the following components.

A. Lid/Filter Mesh Component

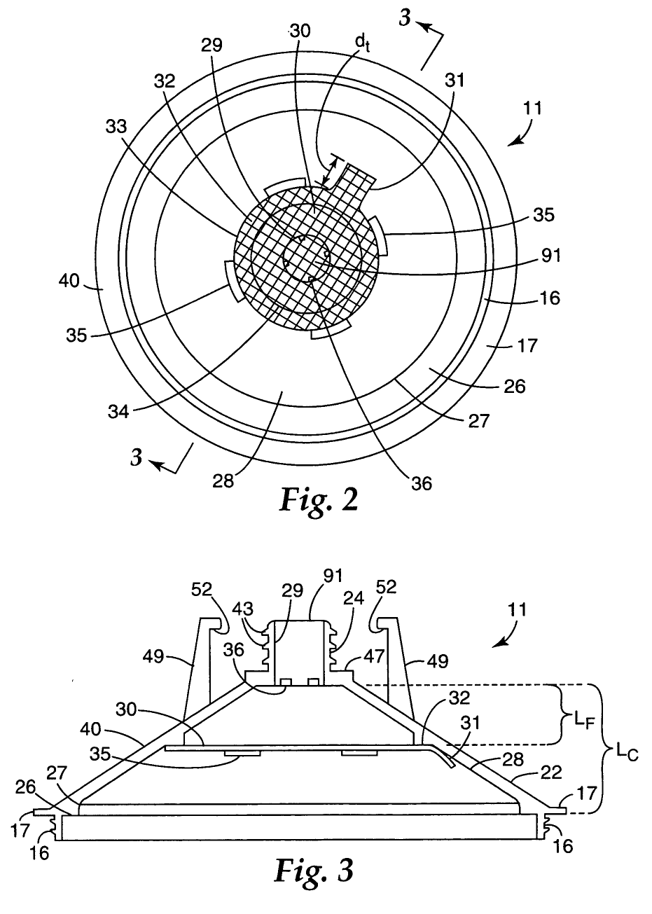

The liquid supply and filter assemblies of the present invention comprise a lid/filter mesh component, such as exemplary lid/filter mesh component 11 of exemplary liquid supply and filter assembly 10. The lid/filter mesh component of the present invention comprises a removably attached filter mesh component as shown in FIG. 2. FIG. 2 provides a bottom view of exemplary lid/filter mesh component 11 shown in exemplary liquid supply and filter assembly 10 of FIG. 1. As shown in FIG. 2, exemplary lid/filter mesh component 11 comprises lid 40. Lid 40 typically comprises an injection molded part formed from a plastic material such as polypropylene. Desirably, lid 40 is transparent to enable viewing of inner surface 28 and other components attached to inner surface 28.

Lid 40 may be formed to have any desired shape. Suitable shapes include, but are not limited to, a conical shape, a cylindrical shape, a tubular shape having a rectangular cross-sectional area, or a tubular shape having a square cross-sectional area. In one desired embodiment, as shown in FIGS. 1-8, lid 40 has a conical shape with a first end and a second end opposite the first end, wherein the second end has a second end cross-sectional area that is smaller than a first end cross-sectional area.

Exemplary lid/filter mesh component 11 further comprises filter mesh 30 having filter tab 31 extending a tab length, dᵢ, from an outer periphery of filter mesh 30. Filter mesh 30 is removably attached to lid 40 along upper lid ledge 32, which has a ledge surface area that extends from outer circumference 33 to inner circumference 34. Desirably, an outer periphery of filter mesh 30 is attached to lid ledge 32 positioned along inner surface 28 of lid 40. In one desired embodiment, upper lid ledge 32 has a surface area that is substantially within a horizontal plane.

Filter mesh 30 may be removably attached to lid 40 using a variety of techniques. Suitable techniques for removably attaching a filter mesh to a lid include, but are not limited to, ultrasonic welding, any thermal bonding technique (e.g., heat and/or pressure applied to melt a portion of the lid, the filter mesh, or both), adhesive bonding, stapling, stitching, etc. In one desired embodiment of the present invention, the filter mesh is removably attached to the lid using an ultrasonic welding process.

As used herein, the phrase “removably attached” is used to describe the degree of adherence between the filter mesh component and the lid. By “removably attached,” it is meant that the filter mesh remains intact with the lid until an outside force (e.g., a pulling force on filter tab 31) is applied to physically remove the filter mesh from the lid. When an outside force, such as a pulling force, exceeds a bonding force between the filter mesh and the upper lid ledge surface area, the filter mesh peels away from the upper lid ridge surface area of the lid. Once removed, the filter mesh is typically not replaceable.

The degree of bonding between filter mesh 30 and lid 40 may vary depending on a number of factors including, but not limited to, the filter mesh material used, the lid material, the bond surface area, and the type of weld used. For example, if the filter mesh has frayed edges, a wider, bonding surface area may be used and/or a knurled ultrasonic weld may be used. A wider, knurled ultrasonic weld captures any frayed edges of the filter mesh. To minimize the amount of fraying, the filter mesh may be cut using a laser, which fuses the edges of the filter mesh material. Since the filter mesh possesses a minimum amount of fraying, if any, a narrower seam weld or bond area may be used. Desirably, the seam weld or bond area extends completely around an outer periphery of the filter mesh, and has an average seam width (i.e., a dimension within the same plane and substantially perpendicular to the outer periphery) up to about 5.0 mm, and more desirably, ranging from about 1.0 mm to about 3.0 mm.

Filter mesh 30 and lid 40 may be formed from a variety of materials. Filter mesh 30 and lid 40 may comprise similar or dissimilar materials. Suitable materials include, but are not limited to, polypropylene, polyethylene, nylon, polyester, or a combination thereof. In one desired embodiment, filter mesh 30 is formed from a nylon mesh fabric, while lid 40 is an injection molded part formed from polypropylene. In this embodiment, the nylon filter mesh is desirably removably attached to the polypropylene lid via an ultrasonic welding technique. During ultrasonic welding, an outer surface layer of upper lid ridge 32 and/or energy directors (not shown) on an outer surface layer of upper lid ridge 32 melt to mechanically bond filter mesh 30 to lid 40. Since nylon has a higher melting temperature than polypropylene, the nylon filter mesh maintains its structural integrity during the ultrasonic welding process. In this exemplary embodiment, a portion of the outer surface layer of upper lid ridge 32 and/or energy directors (not shown) on an outer surface layer of upper lid ridge 32 enter into a portion of filter mesh 30 next to upper lid ridge 32 encapsulating a portion of filter mesh 30.

Filter tab 31 may also be formed from the above-mentioned materials used to form filter mesh 30 and lid 40. Filter tab 31 may be a continuous portion of filter mesh 30 (i.e., may be formed from the same material) or may be a separate component physically, mechanically or adhesively attached to filter mesh 30. Desirably, filter tab 31 is a continuous portion of filter mesh 30 and also comprises nylon (i.e., is cut from a nylon mesh fabric into a shape such as the shape of exemplary filter mesh 30).

Filter mesh 30 and filter tab 31 may have dimensions and shapes that vary for a given application. Filter mesh 30 may have any desired shape including, but not limited to, a circular shape, a square shape, a rectangular shape, a triangular shape, a pentagonal shape, a star shape, etc. In one desired embodiment, filter mesh 30 has a circular shape. Filter tab 31 may also have any desired shape, and, in an embodiment, has a rectangular or square shape. Filter tab 31 may extend from any portion of filter mesh 30, but typically extends outward from an outer periphery of filter mesh 30.

The dimensions of filter mesh 30 and filter tab 31 may vary depending on the lid size. In an embodiment, filter mesh 30 has a largest dimension (i.e., length, width, or diameter) ranging from about 15 mm to about 100 mm although filter mesh 30 may have smaller or larger dimensions. In an embodiment, filter tab 31 has a largest dimension (i.e., typically length) ranging from about 5 mm to about 15 mm although filter tab 31 may have smaller or larger dimensions. For example, in an embodiment a filter mesh having a circular shape and a diameter of about 56 mm has a filter tab extending outward about 10 mm from an outer circumference of the filter mesh.

The mesh fabric used to form filter mesh 30 and filter tab 31 typically comprises a woven mesh having any desired mesh opening size. In an embodiment, the woven mesh has an average mesh opening size of up to about 500 microns, in a further embodiment, less than about 200 microns, and in another embodiment, between about 80 microns to about 200 microns. Suitable mesh sizes that may be used in the present invention include, but are not limited to, any mesh size ranging about 50 microns to about 500 microns and all sizes therebetween. Exemplary mesh sizes used in the present invention include, but are not limited to, 80, 120, and 200 micron mesh filters. In one embodiment, filter mesh 30 and filter tab 31 consist of a single piece of mesh fabric without any additional filter components, wherein filter mesh 30 represents a larger portion of the single piece of mesh fabric, and filter tab 31 extends from said first filter mesh.

As shown in FIG. 2, exemplary lid/filter mesh component 11 further comprises one or more retaining walls 35 positioned on and extending downward from inner surface 28 of lid 40. Typically, retaining walls 35 are integrally molded as a component of lid 40 (i.e., retaining walls 35 are formed during the molding process for forming lid 40). In one exemplary embodiment, as shown in FIG. 2, lid 40 comprises two or more retaining walls 35 extending along inner surface 28 of lid 40, wherein (i) each retaining wall 35 has a retaining wall length greater than a retaining wall thickness, (ii) each retaining wall 35 is positioned along an outer periphery of filter mesh 30, and (iii) a total length of the two or more retaining walls 35 is less than a total length of the outer periphery of filter mesh 30.

As shown in FIG. 2, exemplary lid/filter mesh component 11 comprises four retaining walls 35 equally spaced from one another along outer circumference 33 of upper lid ledge 32. In an embodiment, each retaining wall 35 has a thickness ranging from about 800 microns (μm) to about 1200 μm, a length (i.e., in this exemplary embodiment, an arc length) extending a distance ranging from about 1.0 millimeter (mm) to about 22.0 mm along outer circumference 33, and a height ranging from about 1.0 mm to about 5.0 mm. In an embodiment, each retaining wall 35 has a segmented configuration so as to not inhibit (or minimize the effect on) fluid flow around the retaining wall.

Exemplary lid/filter mesh component 11 also comprises lower lid ledge 26 positioned along an outer periphery of inner surface 28. Circumference 27 shown in FIG. 2 indicates the junction of lower lid ledge 26 and inner surface 28 of lid 40. Inner surface 28 of lid 40 extends upward along a conical shaped portion of lid 40. Inner surface 28 extends to inner surface 29 of cylindrical portion 24 (see, cylindrical portion 24 in FIG. 1) having lid opening 91 therethrough.

In the proximity of the junction between inner surface 28 of lid 40 and inner surface 29 of cylindrical portion 24 and typically along inner surface 29 of cylindrical portion 24, one or more radially inwardly extending members 36 may be positioned. Like the retaining walls described above, extending members 36 are typically integrally molded as a component of lid 40 (i.e., extending members 36 are formed during the molding process for forming lid 40). Extending members 36 may be used to attach a separate, secondary filter element to lid 40 after filter mesh 30 has been separated from lid 40 (discussed below).

In one embodiment, filter mesh 30 has a filter mesh surface area bound by an outer periphery of filter mesh 30, wherein the filter mesh surface area is greater than a smallest cross-sectional area of an opening extending from a first end of lid 40 to a second end of lid 40. In exemplary lid/filter mesh component 11, the smallest cross-sectional area of an opening extending from a first end of lid 40 to a second end of lid 40 is the cross-sectional area of opening 91. In one exemplary embodiment, lid 40 has a conical shape, opening 91 has a circular cross-sectional configuration, and filter mesh 30 has a circular shape. In a further exemplary embodiment, opening 91 extends through a central portion of lid 40 from the first end to the second end of lid 40, and filter mesh 30 has a filter mesh surface area bound by an outer periphery of filter mesh 30, and the filter mesh surface area is greater than the cross-sectional area of opening 91.

As shown in FIG. 1, the lid/filter mesh component may further comprise one or more components capable of connecting to (i) a liquid spraying device or (ii) an adapter capable of connecting to the liquid spraying device, wherein the one or more components are positioned on an outer surface and at a second end of the lid component. For example, as shown in exemplary lid/filter mesh component 11, the lid/filter mesh component may comprise axially-spaced radially outwardly projecting sealing rings 43 along the outer surface of cylindrical portion 24 positioned on boss 47, and opposed inwardly projecting lips 52 on the distal ends of projecting hook members 49, which are equally spaced from and on either side of cylindrical portion 24 extending from outer surface 22 of exemplary lid/filter mesh component 11.

The above-described component features may be used to attach the lid/filter mesh component to a spraying device as described in U.S. Pat. No. 6,536,687, the subject matter of which is incorporated herein in its entirety by reference. (See, in particular, FIGS. 1-3 and the accompanying disclosure for a description of an exemplary system of attaching the lid/filter mesh component of the present invention to a spraying device.)

A cross-sectional view of exemplary lid/filter mesh component 11 shown along line 3-3 of FIG. 2 is provided in FIG. 3. As shown in FIG. 3, filter mesh 30 with filter tab 31 is positioned a distance L_{f} from cylindrical portion 24 of lid 40. It should be understood that filter mesh 30 with filter tab 31 may be positioned a distance L_{f} from cylindrical portion 24, wherein L_{f} ranges from about 0.0 mm to L_{c}, the total distance from cylindrical portion 24 to lower lid ledge 26 of lid 40. In an embodiment, L_{c} is up to about 45 mm and filter mesh 30 with filter tab 31 is positioned a distance L_{f} from cylindrical portion 24, wherein L_{f} ranges from about 10.0 mm to about 25 mm. In one exemplary embodiment wherein L_{c} is equal to about 45 mm, L_{f} is equal to about 25 mm.

Although not shown in FIGS. 2-3, it should be noted that lid/filter mesh component 11 may comprise more than one removably attached filter component (e.g., more than one filter mesh 30 with filter tab 31). In one exemplary embodiment, lid/filter mesh component 11 comprises (i) a first removably attached filter component, such as filter mesh 30 with filter tab 31, as shown in FIGS. 2-3, and (ii) a second removably attached filter component, similar to filter mesh 30 with filter tab 31, attached along lower lid ledge 26 of lid 40. In this exemplary embodiment, the filter components may be similar to one another (e.g., both filter components may be filter mesh materials) or different from one another (e.g., a filter mesh material and a filter element as shown in FIG. 6).

In one embodiment having more than one filter component, the lid/filter mesh component comprises (i) a first removably attached filter component comprising a first filter mesh with a first filter tab positioned along an upper lid ledge (such as upper lid ledge 32), and (ii) a second removably attached filter component comprising a second filter mesh with a second filter tab positioned along a lower lid ledge (such as lower lid ledge 26), wherein the first filter mesh has a smaller mesh size than the second filter mesh. For example, in one exemplary embodiment, the first filter mesh with first filter tab positioned along an upper lid ledge (such as upper lid ledge 32) has a diameter of about 56 mm, a mesh size of about 80 microns, and is partially surrounded by one or more retaining walls (e.g., retaining walls 35 of lid 40 in FIG. 3), while the second filter mesh with second filter tab positioned along a lower lid ledge (such as lower lid ledge 26) has a diameter of about 96 mm, a mesh size of about 200 microns, and is surrounded by an inner wall surface of the lid (e.g., lower portion 16 of lid 40 in FIG. 3).

B. Container

The liquid supply and filter assemblies of the present invention further comprise a container, such as container 12 of exemplary liquid supply and filter assembly 10. The container typically has at least one container side wall, a container bottom end, a container top end having a container opening therein, and a first set of threads extending along the at least one container side wall. In one exemplary embodiment, container 12 functions as a reservoir capable of containing one or more liquids, and the container further comprises a closable opening in the at least one container side wall, the container bottom end, or both. In a further embodiment, container 12 supports a liner, wherein the liner is capable of containing one or more liquids.

As shown in FIG. 1, exemplary container 12 comprises a generally cylindrical side wall 48 having top and bottom ends 41 and 42, a bottom wall 44 extending across and closing bottom end 42 of side wall 48, and an upper surface 15 around top end 41 of side wall 48. Top end 41 of side wall 48 defines an opening into container 12. Side wall 48 may bear indicia 25, for example, indicating the levels to which one or more liquids should be sequentially poured into container 12 (or liner 13) to provide a predetermined ratio between one or more liquids. Desirably, side wall 48 is sufficiently transparent to afford seeing the liquid level in container 12 through side wall 48, which assists a person in adding liquids to the desired levels indicated by indicia 25. Side wall 48 may also bear other types of indicia, such as trademarks, brand names and the like.

The container may further comprise one or more additional features. In one exemplary embodiment, such as exemplary container 12 shown in FIG. 1, container 12 further comprises threads 21 along an outer surface of side wall 48 at top end 41. As discussed above, threads 21 are used to secure container 12 to other components of the liquid supply and filter assemblies (e.g., lid/filter mesh component 11, liner 13, and/or collar 20). In a further exemplary embodiment, such as exemplary container 12 shown in FIG. 1, container 12 comprises an opening 45 in bottom wall 44. Opening 45 may be used to access a liner positioned within container 12. For example, in order to improve fluid flow of liquid within a collapsible liner positioned within the container, a user may access the liner through opening 45 in container 12, and puncture the liner to allow air flow into the liner although puncturing the liner is not necessary, in most cases, to have adequate fluid flow. When present, opening 45 typically has a circular shape and an overall diameter of about 3.0 cm, although opening 45 can have any dimension and/or shape. Further, when present, opening 45 may be closable.

Container 12 may be formed from a plastic material, for example, polyethylene or polypropylene, and may be transparent, translucent (as shown in FIG. 1) or opaque, and of any suitable size. For use with a paint spray gun, containers typically have a capacity of about 250, 500 or 800 ml, although other sizes are possible.

The liquid supply and filter assemblies of the present invention may comprise a container in combination with a liner (described below). In an alternative embodiment, the liquid supply and filter assembly of the present invention does not comprise a liner. In this embodiment, the container comprises a closable opening (i.e., similar to opening 45 but with a separate or attached component (not shown) used to close the opening). The closable opening enables a liquid, such as paint, to be poured into the linerless container without leakage of the liquid. Once the container is inverted to allow liquid to flow toward the open end of the container (i.e., top end 41), the closure component may be removed from the opening to enable enhanced liquid flow due to the absence of a vacuum within the container. When desired, the closure component may be replaced into the opening to reseal the opening.

C. Liner

The liquid supply and filter assemblies of the present invention may further comprise a liner, such as liner 13 of exemplary liquid supply and filter assembly 10. When present, the liner desirably has at least one liner side wall, a liner bottom end, a liner top end having a liner opening therein, and a liner rim extending along and protruding from the liner top end. When used, the liner functions as a reservoir capable of containing one or more liquids.

As shown in FIG. 1, exemplary liner 13 has an outer shape similar to the interior of container 12 and has a liner rim 14 at the open end which is capable of resting on upper container surface 15. Liner 13 is desirably self-supporting and collapsible. In one exemplary embodiment, liner 13 has a comparatively rigid base 13A and comparatively thin side walls 13B so that, when liner 13 collapses, liner 13 collapses in the longitudinal direction by virtue of the side walls collapsing rather than the base. In addition, liner 13 desirably has no pleats, corrugations, seams, joints or gussets, and also no groove at the internal junction of the side walls 13B with the base 13A.

Typically, liner 13 comprises a polymeric material, such as polypropylene or polyethylene, and is formed from a molding process such as a thermoforming process. In one embodiment of the present invention, liner 13 comprises thermoformed low density polyethylene.

In one embodiment of the present invention, the liquid supply and filter assembly comprises a liner, such as liner 13, in combination with a container, such as container 12 described above. In this embodiment, liquid, such as paint, only comes into contact with inner walls of the liner. Further, in this embodiment, container 12 is a vented container, namely, container 12 comprises an opening in container bottom wall 44 (e.g., opening 45 shown in FIG. 1). In the case of a collapsible liner in combination with a vented container (i.e., a container comprising an opening such as opening 45 shown in FIG. 1), such an assembly provides exceptional liquid flow from the liner.

D. Collar

The liquid supply and filter assemblies of the present invention may further comprise a collar, such as collar 20 of exemplary liquid supply and filter assembly 10. When present, the collar, in an embodiment, has a top end having a collar opening therein, a bottom end, and at least one collar side wall extending between the top end and the bottom end, a collar rim extending along the top end and protruding into the collar opening, and a second set of threads extending along the at least one collar side wall, wherein the second set of threads is capable of engaging with a first set of threads on the container (described above).

As shown in FIG. 1 and as discussed above, collar 20 comprises upper rim 18 and collar threads 19 positioned on an inner surface of collar 20. Upper rim 18 and collar threads 19 work along with container threads 21 to secure lid/filter mesh component 11 and liner 13 in a liquid supply and filter assembly.

Collar 20 may be a molded plastic component, or may be a machined metal (for example, aluminum) component. In an embodiment, collar 20 is a molded plastic component comprising glass fiber reinforced polypropylene.

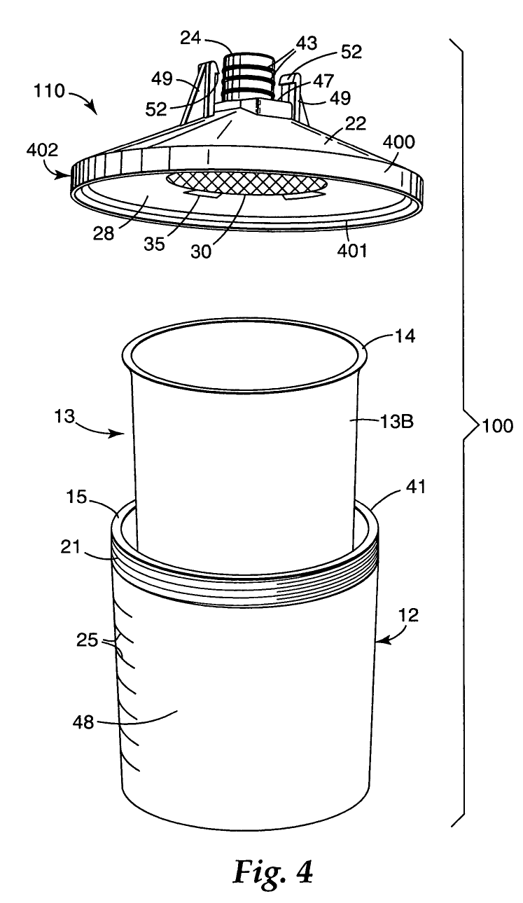

In a further exemplary embodiment of the present invention as shown in FIG. 4, collar 20 is not necessary due to an alternative design of lid 40. In this embodiment, the lid component comprises a second set of threads extending along an outer surface of the lid component proximate the first end of the lid component. The second set of threads is capable of engaging with a first set of threads on the container (described above).

As shown in FIG. 4, exemplary liquid supply and filter assembly 100 comprises lid/filter mesh component 110 including lid 400 and filter mesh 30 partially bound by retaining walls 35. Lid 400 comprises inner threads 401 positioned along an inner surface of end 402 opposite cylindrical portion 24. Inner threads 401 engage with container threads 21 positioned on side wall 48 at top end 41 of container 12 to secure liner 13 in place between lid 400 and container 12.

E. Replacement Filter Element

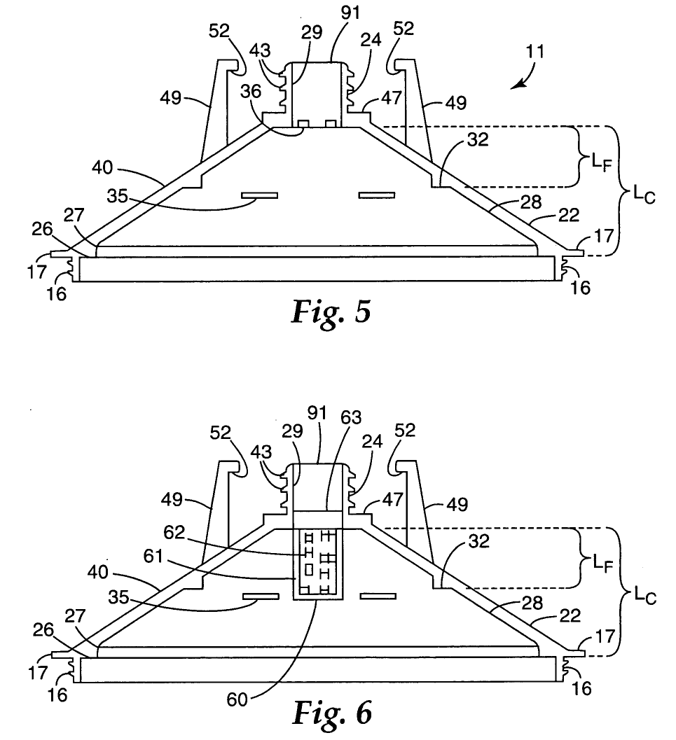

The liquid supply and filter assemblies of the present invention may further comprise a replacement filter element, such as filter element 60 shown in FIG. 6. Referring first to FIG. 5, FIG. 5 provides an enlarged cross-sectional view of the exemplary lid/filter mesh component of FIG. 2 as viewed along section line 3-3 after filter mesh 30 has been removed from (i.e., peeled from) lid 40. Once filter mesh has been removed, a user may choose to use lid 40 to apply one or more liquids without filtration of the one or more liquids. If a user wants to use lid 40 to apply one or more liquids with filtration, the user may attach a replacement filter element as shown in FIG. 6.

FIG. 6 provides an enlarged cross-sectional view of exemplary lid 40 with replacement filter element 60 attached thereto. Replacement filter element 60 includes a stiff polymeric cylindrical frame portion 61 having an upper end 63 that is engaged with one or more radially inwardly extending members 36 positioned along inner surface 29 of cylindrical portion 24. Replacement filter element 60 also includes filter screen 62 extending along a periphery of cylindrical frame portion 61. Examples of replacement filter elements similar to replacement filter element 60 are disclosed in U.S. Pat. No. 6,536,687, the subject matter of which is incorporated herein in its entirety.

II. Methods of Making Liquid Supply and Filter Assemblies

In one exemplary embodiment, a method of making a liquid supply and filter assembly comprises the steps of (a) providing a lid component comprising a first end suitable for engaging a reservoir capable of containing one or more liquids; a second end opposite the first end, wherein the second end has a second end cross-sectional area that is smaller than a first end cross-sectional area; an inner surface and an outer surface both of which extend from the first end to the second end; and an opening extending through a central portion of the lid component from the first end to the second end; and (b) attaching at least one removable filter component to the inner surface of the lid component, wherein the at least one removable filter component comprises a filter mesh and a filter tab extending from the filter mesh.

The step of providing a lid component may simply comprise obtaining a lid component from a commercial source. Alternatively, the step of providing a lid component may comprise forming a lid component. As discussed above, the lid component is typically formed by an injection molding process, wherein polymeric material is injected into a mold having a configuration substantially similar to the desired configuration of the lid component. However, any known molding process, including injection molding processes, may be used to form the lid component.

As discussed above, the method of attaching a removable filter component to the inner surface of the lid component may comprise any bonding method including, but not limited to, ultrasonic welding, any thermal bonding technique (e.g., heat and/or pressure applied to melt a portion of the lid, the filter mesh, or both), adhesive bonding, stapling, stitching, etc. Desirably, the at least one removable filter component is removably attached to the lid component using an ultrasonic welding process.

In one exemplary ultrasonic welding process, a filter component, such as filter mesh 30 and filter tab 31, is brought into contact with the lid component. When positioned on an upper lid ledge (such as upper lid ledge 32), retaining walls (such as retaining walls 35) provide a barrier so that the filter component can not move out of a desired position. Although not shown in the figures, lid ledges such as upper lid ledge 32 desirably comprise multiple energy directors along an outer surface of the lid ledge. Energy directors are typically formed during a molding process, such as an injection molding process, and represent raised areas along the outer surface of the lid ledge. In an embodiment, exemplary energy directors have a pyramidal shape, a height of about 0.38 mm, a side length of about 0.76 mm, and a side wall slope (i.e., the angle between a side wall of the pyramidal structure and the outer surface of the lid ledge) of about 45 degrees.

During an ultrasonic welding step, energy is focused on the energy directors, which causes the energy directors to melt before the outer surface of the lid ledge melts. In the resulting structure, the polymer mass within the energy directors is the primary material that enters into the filter component and “mechanically” bonds the filter component to the lid component. As used herein, the term “mechanically bonds” is used to describe a bond between the lid and a filter component, wherein a portion of the lid (e.g., an energy director) melts and impregnates a portion of the filter component so as to encapsulate a portion of the filter component. Upon cooling below a melt temperature of the lid portion, the lid portion solidifies to capture a portion of the filter component within the solidified lid portion. In an embodiment where a polypropylene lid and nylon mesh filter are used, since polypropylene has a lower melting temperature than nylon, the polypropylene melts around and encapsulates the nylon fibers. Stated another way, a mechanical bond between the polymers is a bond wherein the polymers do not mix at a molecular level.

Any ultrasonic welding device may be used in the present invention. Suitable commercially available ultrasonic welding devices include, but are not limited to, ultrasonic welding devices commercially available from Branson Ultrasonic Corporation (Danbury, Conn.) such as welder model Branson 2000 aed 2.5.

Following attachment of the one or more filter components to the lid component, the lid/filter mesh component may be further assembled with the other components of the liquid supply and filter assembly as described above. Once the liner (or linerless container with closable opening) contains one or more liquids, the liquid supply and filter assembly may be attached to a spray device as described above.

III. Methods of Using Liquid Supply and Filter Assemblies

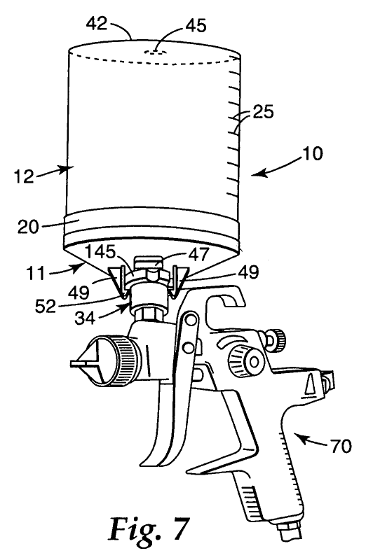

Also disclosed are methods of using the above-described liquid supply and filter assemblies to apply a liquid onto a substrate. The above-described liquid supply and filter assemblies, while suitable for use with any type of spraying device, are particularly useful on gravity-fed spraying devices, such as exemplary spraying device 70 shown in FIG. 7, as well as similar gravity-fed spraying devices disclosed in International Publication Number WO 98/32539, U.S. Pat. No. 6,536,687, and U.S. Pat. No. 6,588,681, the subject matter of all of which is incorporated herein in its entirety by reference.

Spraying devices are commercially available from a number of sources including, but not limited to, Anest Iwata USA Inc. (West Chester, Ohio). One exemplary commercially available spraying device is available from Anest Iwata USA Inc. (West Chester, Ohio) under the trade designation W400.

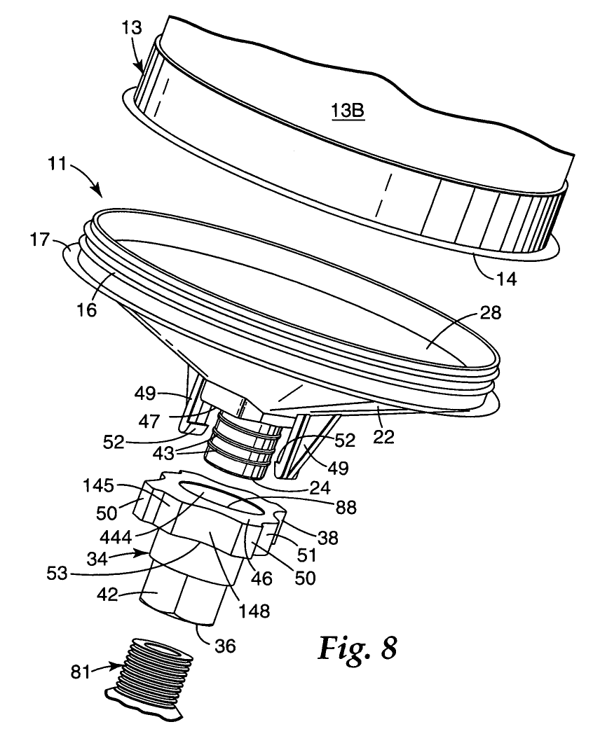

As shown in FIG. 7, exemplary liquid supply and filter assembly 10 may be attached to exemplary spraying device 70 via adapter 34. Adapter 34 fits over cylindrical portion 24 of lid 40 and engages with opposed inwardly projecting lips 52 on the distal ends of projecting hook members 49 of lid 40. A more detailed view of adapter 34 and the connection between exemplary liquid supply and filter assembly 10 and exemplary spraying device 70 is provided in FIG. 8.

As shown in FIG. 8, exemplary adapter 34 comprises first and second spaced end portions 36 and 38, and has a through opening 88 extending through end portions 36 and 38. First end portion 36 of adapter 34 has internal threads (not shown) and six flatted wrench engagable surface portions 42 around a periphery of first end portion 36, thereby being adapted to be releasably engaged with external threads on an inlet port 81 of exemplary spraying device 70. Lid 40 and second end portion 38 of adapter 34 have connector parts that are adapted for releasable liquid tight engagement with their through openings 91 and 88 in communication with one another.

When engaged, cylindrical portion 24 of lid 40 with sealing rings 43 is in liquid tight engagement with inner surface 444 of adapter 34. Further, end surface 46 on adapter collar 145 surrounding second end portion 38 of adapter 34 abuts boss 47 of lid 40 around cylindrical portion 24. Adapter collar 145 has major cylindrically concave recesses 148 along opposite sides adapted to pass distal ends of hook members 49 projecting from outer surface 22 of lid 40 on opposite sides of cylindrical portion 24 when cylindrical portion 24 is pressed axially into opening 88 of adapter 34. At this point, lid 40 and adapter 34 are in a first relative position in which hook members 49 are aligned with major recesses 148 in adapter collar 145. Lid 40 and adapter 34 can then be rotated relative to each other to a second relative position to cause the resiliently flexible projecting hook members 49 to move around and locate into minor concave recesses 51. In this second relative position, projecting hook members 49 are positioned in minor cylindrically concave recesses 51 in adapter collar 145 while opposed inwardly projecting lips 52 on distal ends of projecting hook members 49 are engaged over a surface 53 of adapter collar 145 adjacent first end 36 of adapter 34.

Adapter 34 may be formed from a polymeric or metallic material. In one desired embodiment, adapter 34 is formed from a metallic material (e.g., stainless steel).

Prior to beginning the above-described connection steps or after partial completion of the above-described connection steps, a user may first mix one or more liquids in container 12 using indicia 25 to indicate the levels to which each liquid should be sequentially poured into container 12 to achieve a desired ratio between the one or more liquids. Any indicia 25 may be used on container 12 to assist a user when measuring one or more liquids. One exemplary indicia suitable for use in the present invention comprises indicia disclosed in U.S. Pat. No. 6,588,681 (i.e., indicia 25 on indicating sheet 24 shown in FIG. 1 of U.S. Pat. No. 6,588,681), the subject matter of which is incorporated herein in its entirety by reference.

Typically, one or more liquids are poured into liner 13 described above. In an alternative embodiment, one or more liquids are poured directly into container 12. In this embodiment, liner 13 is not used, and a lid/filter mesh component, similar to exemplary lid/filter mesh component 110 shown in FIG. 4, is instead attached directly to container 12 containing one or more liquids.

When liner 13 is used, liner 13 may be filled prior to or after being positioned within container 12. After filling liner 13 or container 12 to a desired level, lid/filter mesh component 11 or 110 is engaged with liner 13 or container 12 respectively. When lid/filter mesh component 11 is used and after engaging with liner 13, collar 20 is screwed onto container 12 as described above. Once the liquid supply and filter assembly is assembled, the liquid supply and filter assembly may be connected to a spraying device as described above.

After connecting the liquid supply and filter assembly of the present invention to a spraying device, the spraying device is inverted as shown in FIG. 7 and ready for use. Gravity feeds the one or more liquids in liner 13 (or container 12 with a closable opening) into spraying device 70. As discussed above, the method of use may further comprise puncturing liner 13 (or removing a closure device in container 12) in the proximity of rigid base 13A (or bottom end 42 for container 12) to enable air flow into liner 13 (or container 12 with a closable opening) as liquid is sprayed to minimize or eliminate the formation of a vacuum in liner 13 (or container 12 with a closable opening). However, puncturing of liner 13 is not required and, in most cases, is not recommended. If liquid remains in liner 13 (or container 12 with a closable opening) after use of spraying device 70, a pin or other object can be inserted into the punctured area, if necessary, to restrict leakage of liquid from liner 13 (or the closure device may be replaced in container 12).

When a given spray job is completed, spraying device 11 can be inverted into a position so that any remaining liquid in liner 13 (or container 12 with a closable opening) is not in contact with lid/filter mesh component 11 or 110. In this position, the connector components can be disconnected. Any remaining liquid (if non-catalyzed) can be stored for future use in liner 13 (or container 12 with a closable opening) if so desired. Lid/filter mesh component 11 or 110, liner 13, container 12 and/or collar 20 may be cleaned and reused or simply discarded.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A liquid supply and filter assembly comprising:
a lid component comprising:
a first end suitable for connecting to a reservoir capable of containing one or more liquids,
a second end opposite the first end,
an inner surface and an outer surface both of which extend from the first end to the second end, and
an opening extending through a portion of the lid component from the first end to the second end; and
a first removably attached filter component attached to the inner surface of the lid component, said first removably attached filter component comprising:
a first filter mesh; and
a first filter tab extending from the first filter mesh.

2. The assembly of claim 1, wherein an outer periphery of the first filter mesh is attached to a lid ledge positioned along the inner surface of the lid component.

3. The assembly of claim 1, wherein the first filter mesh has a first filter mesh surface area bound by the outer periphery of the first filter mesh, and the first filter mesh surface area is greater than a smallest cross-sectional area of the opening.

4. The assembly of claim 1, wherein the lid component has a conical shape, the opening has a circular cross-sectional configuration, and the first filter mesh has a circular shape.

5. The assembly of claim 1, wherein the first removably attached filter component consists of a single mesh fabric, and the first filter mesh is larger than the first filter tab.

6. The assembly of claim 1, wherein the opening extends through a central portion of the lid component from the first end to the second end, and the first filter mesh has a first filter mesh surface area bound by an outer periphery of the first filter mesh, and the first filter mesh surface area is greater than a smallest cross-sectional area of the opening.

7. The assembly of claim 1, wherein the first removably attached filter component and the lid component comprise similar or dissimilar materials.

8. The assembly of claim 1, wherein the first removably attached filter component comprises a nylon mesh fabric, and the lid component comprises an injection molded polypropylene part.

9. The assembly of claim 1, wherein the first removably attached filter component is ultrasonically welded to the lid component.

10. The assembly of claim 1, further comprising at least one more removably attached filter component attached to the inner surface of the lid component.

11. The assembly of claim 10, wherein the at least one more removably attached filter component comprises:
a filter mesh; and
a filter tab extending from the filter mesh.

12. The assembly of claim 11, wherein the first filter mesh has a mesh size smaller than the at least one more filter mesh.

13. The assembly of claim 1, wherein the first filter mesh has a mesh size ranging from about 80 microns to about 200 microns.

14. The assembly of claim 1, wherein the lid component further comprises two or more retaining walls extending along the inner surface of the lid component, wherein (i) each retaining wall has a retaining wall length greater than a retaining wall thickness, (ii) each retaining wall is positioned along an outer periphery of the first filter mesh, and (iii) a total length of the two or more retaining walls is less than a total length of the outer periphery of the first filter mesh.

15. The assembly of claim 1, wherein the lid component further comprises one or more components capable of connecting to (i) a liquid spraying device or (ii) an adapter capable of connecting to the liquid spraying device, the one or more components being positioned on the outer surface and at the second end of the lid component.

16. The assembly of claim 1, further comprising a container, the container having at least one container side wall, a container bottom end, a container top end having a container opening therein, and a first set of threads extending along the at least one container side wall.

17. The assembly of claim 16, wherein the container is capable of containing one or more liquids, and the container further comprises a closable opening in the at least one container side wall, the container bottom end, or both.

18. The assembly of claim 16, further comprising a liner, the liner having at least one liner side wall, a liner bottom end, a liner top end having a liner opening therein, and a liner rim extending along and protruding from the liner top end, the liner being capable of containing one or more liquids.

19. The assembly of claim 18, wherein the container comprises an opening in the container bottom end.

20. The assembly of claim 16, further comprising a collar, the collar having a top end having a collar opening therein, a bottom end, and at least one collar side wall extending between the top end and the bottom end, a collar rim extending along the top end and protruding into the collar opening, and a second set of threads extending along the at least one collar side wall, the second set of threads capable of connecting to the first set of threads on the container.

21. The assembly of claim 16, wherein the lid component comprises a second set of threads extending along the outer surface proximate the first end of the lid component, the second set of threads capable of connecting to the first set of threads on the container.

22. The assembly of claim 1, wherein the second end has a second end cross-sectional area that is smaller than a first end cross-sectional area.

23. A spraying device comprising the assembly of claim 1.

24. A spraying device comprising the assembly of claim 20.

25. A spraying device comprising the assembly of claim 21.

26. A lid/filter mesh component suitable for use in a liquid supply assembly, the lid/filter mesh component comprising:
a lid component comprising:
a first end suitable for connecting to a reservoir capable of containing one or more liquids,
a second end opposite the first end,
an inner surface and an outer surface both of which extend from the first end to the second end, and
an opening extending through a portion of the lid component from the first end to the second end; and
a first removably attached filter component attached to the inner surface of the lid component, the first removably attached filter component comprising:
a first filter mesh; and
a first filter tab extending from the first filter mesh.

27. The lid/filter mesh component of claim 26, wherein an outer periphery of the first filter mesh is attached to a lid ledge positioned along the inner surface of the lid component.

28. The lid/filter mesh component of claim 26, wherein the first filter mesh has a first filter mesh surface area bound by the outer periphery of the first filter mesh, and the first filter mesh surface area is greater than a smallest cross-sectional area of the opening.

29. The lid/filter mesh component of claim 26, wherein the first removably attached filter component consists of a single mesh fabric, the first filter mesh representing a larger portion of the single mesh fabric, and the first filter tab extending from the first filter mesh.

30. The lid/filter mesh component of claim 29, wherein the single mesh fabric consists of a nylon mesh fabric, and the lid component comprises an injection molded polypropylene part.

31. The lid/filter mesh component of claim 26, further comprising two or more retaining walls extending along the inner surface of the lid component, wherein (i) each retaining wall has a retaining wall length greater than a retaining wall thickness, (ii) each retaining wall is positioned along an outer periphery of the first filter mesh, and (iii) a total length of the two or more retaining walls is less than a total length of the outer periphery of the first filter mesh.

32. The lid/filter mesh component of claim 26, further comprising one or more components capable of connecting to (i) a liquid spraying device or (ii) an adapter capable of connecting to the liquid spraying device, the one or more components being positioned on the outer surface and at the second end of the lid component.

33. The lid/filter mesh component of claim 26, further comprising at least one more removably attached filter component attached to the inner surface of the lid component, the at least one more removably attached filter component comprising:
a filter mesh; and
a filter tab extending from the filter mesh.

34. The lid/filter mesh component of claim 26, wherein the second end has a second end cross-sectional area that is smaller than a first end cross-sectional area.

35. A liquid supply and filter assembly comprising:
a lid/filter mesh component comprising:
a lid component comprising:
a first end suitable for connecting to a reservoir capable of containing one or more liquids,
a second end opposite the first end,
an inner surface and an outer surface both of which extend from the first end to the second end, and
an opening extending through a portion of the lid component from the first end to the second end;
a first removably attached filter component attached to the inner surface of the lid component, the first removably attached filter component comprising:
a first filter mesh; and
a first filter tab extending from the first filter mesh;
a container having (i) at least one container side wall, (ii) a container bottom end, (iii) a container top end having a container opening therein, and (iv) a first set of threads extending along the at least one container side wall;
an optional liner, the liner having (i) at least one liner side wall, (ii) a liner bottom end, (iii) a liner top end having a liner opening therein, and (iv) a liner rim extending along and protruding from the liner top end, said liner being capable of containing one or more liquids; and
an optional collar, the collar having (i) a top end having a collar opening therein, (ii) a bottom end, (iii) at least one collar side wall extending between the top end and the bottom end, (iv) a collar rim extending along the top end and protruding into the collar opening, and (v) a second set of threads extending along the at least one collar side wall, said second set of threads capable of connecting to the first set of threads on the container;
wherein the lid component, the container, the optional liner and the optional collar are capable of being configured and combined with one another to form a leak proof liquid supply and filter assembly, the leak proof liquid supply and filter assembly capable of connecting to a gravity fed liquid spraying device.

36. The assembly of claim 35, further comprising at least one more removably attached filter component attached to the inner surface of the lid component, the at least one more removably attached filter component comprising:
a filter mesh; and
a filter tab extending from the filter mesh.

37. The assembly of claim 35, wherein the second end has a second end cross-sectional area that is smaller than a first end cross-sectional area.
